(19) United States
(12) Patent Application Publication
(10) Pub. No.: US 2003/0066074 A1
(43) Pub. Date: Apr. 3, 2003

(54) System and method for displaying group viewing statistics during television viewing

(75) Inventors: John Zimmerman, Ossining, NY (US); Nevenka Dimitrova, Yorktown Heights, NY (US)

Correspondence Address: Corporate Patent Counsel, U.S. Philips Corporation, 580 White Plains Road, Tarrytown, NY, 10591, US

(73) Assignee: Koninklijke Philips Electronics N.V., Eindhoven (NL)

(21) Appl. No.: 09/967,867

(22) Filed: Sep. 29, 2001

(51) Int. Cl. H04N 7/16; H04H 9/00

(52) U.S. Cl. 725/14; 725/20

(57) ABSTRACT

There is disclosed a television apparatus for viewing group viewing statistics pertaining to groups of friends of a viewer. The television apparatus comprises a viewing statistics controller capable of receiving incoming television signals from a broadcast source and extracting from the incoming television signals viewer statistical data transmitted by the broadcast source, wherein the viewing statistics controller displays on a television screen associated with the television apparatus at least a portion of the viewer statistical data associated with a viewer group selected by a viewer operating the television apparatus.

### TECHNICAL FIELD OF THE INVENTION

The present invention is directed, in general, to television broadcasting systems and, more specifically, to a system for receiving group viewing statistics from a broadcast facility and displaying the statistics to a viewer on a television set.

### BACKGROUND OF THE INVENTION

After television was first widely introduced in the 1950s, television viewing quickly became a family-centered activity. More recently, however, television viewing has become much less a group activity and much more a solitary activity. This change is due in part to societal changes that have resulted in more single parent families, in which children often watch TV while the one parent works, and more two parent families in which both parents work and the children watch TV while one or both parents work. Also, a vast increase in the number of television channels available and a similar increase in the diversity of TV programming gives individuals with diverse tastes more viewing options. As a result family members often watch different programs on different televisions within the same home.

However, solitary viewing of television does not give the viewer the enjoyment of a group experience, as in the case of family viewing. There is no interaction with others to complement the televised program and the viewer has no one with whom to share laughter or sadness. It would be beneficial to provide a solitary television viewer (or a small group of viewers) with some sense of a shared experience.

### SUMMARY OF THE INVENTION

To address the above-discussed deficiencies of the prior art, it is a primary object of the present invention to provide a television apparatus for viewing group viewing statistics pertaining to groups of friends of a viewer. According to an advantageous embodiment of the present invention, the television apparatus comprises a viewing statistics controller capable of receiving incoming television signals from a broadcast source and extracting from the incoming television signals viewer statistical data transmitted by the broadcast source, wherein the viewing statistics controller displays on a television screen associated with the television apparatus at least a portion of the viewer statistical data associated with a viewer group selected by a viewer operating the television apparatus.

According to one embodiment of the present invention, the viewing statistics controller intermittently transmits to the broadcast source viewed channel data identifying television programs viewed by the viewer.

According to another embodiment of the present invention, the viewing statistics controller displays the at least a portion of the viewer statistical data in response to a command prompt entered by the viewer.

According to still another embodiment of the present invention, the viewing statistics controller displays the at least a portion of the viewer statistical data periodically.

According to yet another embodiment of the present invention, members of the viewer group are determined by the viewer and the viewing statistics controller transmits to the broadcast source identification data identifying the members of the viewer group.

According to a further embodiment of the present invention, receipt of the identification data causes the broadcast source to monitor viewed channel data identifying television programs viewed by the members of the viewer group.

According to a still further embodiment of the present invention, the viewing statistics controller comprises a graphical user interface operable to display on the television screen the at least a portion of the viewer statistical data associated with the viewer group.

According to a yet further embodiment of the present invention, the viewer selects the viewer group via the graphical user interface.

In one embodiment of the present invention, the television apparatus is disposed within a television set.

In another embodiment of the present invention, the television apparatus is disposed within a set-top box associated with the television screen.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the DETAILED DESCRIPTION, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. In particular, a controller may comprise one or more data processors, and associated input/output devices and memory, that execute one or more application programs and/or an operating system program. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates exemplary television broadcast system 10 according to one embodiment of the present invention;

FIG. 2 illustrates an exemplary set-top box (STB) and a television set according to one embodiment of the present invention;

FIG. 3 illustrates in greater detail the exemplary set-top box according to one embodiment of the present invention; and

FIG. 4 is a flow diagram illustrating the operation of the exemplary set-top box and broadcast facility according to one embodiment of the present invention.

### DETAILED DESCRIPTION OF THE INVENTION

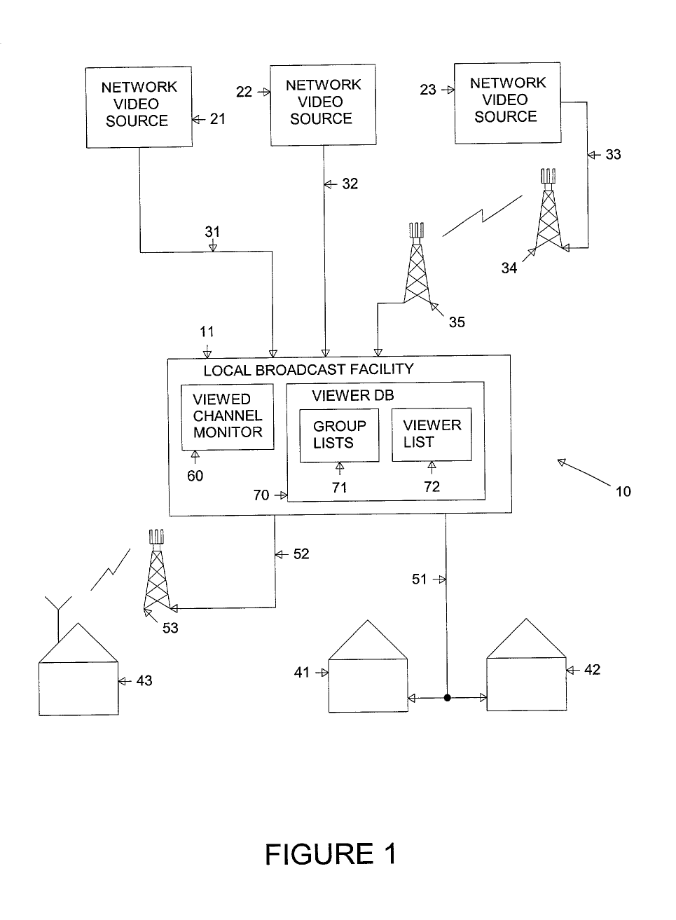

FIGS. 1 through 4, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged set-top box (STB) and broadcast facility.

FIG. 1 illustrates exemplary television broadcast system 10 according to one embodiment of the present invention. Television broadcast system 10 comprises local broadcast facility 11, which receives one or more digital video transport streams from each of network video sources 21-23. Local broadcast facility 10 may receive these digital video transport streams from wireline communication links or from wireless communication links. For example, local broadcast facility 10 receives one or more digital video transport streams from network video source 21 via wireline communication link 31 and receives one or more digital video transport streams from network video source 22 via wireline communication link 32.

Local broadcast facility 11 also comprises base transceiver stations 34 and 35, which wirelessly transmit one or more digital video transport streams from network video source 23 to local broadcast facility 11. In an exemplary embodiment, network video source 23 may transmit the digital video transport streams via communication line 33 to base transceiver station 34, which is part of a local multipoint distribution system (LMDS) network. In an LMDS network, a microwave link is used to transmit the digital video transport stream from base transceiver station 34 to base transceiver station 35.

Local broadcast facility 11 transmits the digital video transport streams to subscriber locations 41-43, which may include both private residences and business locations. If local broadcast facility 11 is part of a cable television system, local broadcast facility 11 may transmit one or more outbound digital video transport streams to subscriber locations 41 and 42 via communication wireline 51. Communication wireline 52 carries one or more outbound digital video transport streams from local broadcast facility 11 to transmitter 43, which wirelessly transmits the outbound digital video transport streams to subscriber location 43.

Each of the digital video transport streams received by and transmitted by local broadcast facility are carried in a 6 MHz broadcast channel. A transport stream usually contains several virtual channels, with each virtual channel containing a program. The program carried in a virtual channel is what a viewer sees on a signal television channel, such as a movie, a newscast, and a weather channel. Normally, each virtual channel is allocated a fixed bandwidth, such as 3 Megabits per second (Mbps).

Local broadcast facility 11 also comprises viewed channel monitor 60 and viewer data base (DB) 70, which stores group lists 71 and viewer list 72. Viewed channel monitor 60 communicates bidirectionally with associated monitoring apparatuses in set-top boxes in subscriber locations in order to gather viewing statistics from each viewer and to distribute group viewing statistics to each viewer. All viewer profile information gathered from individual viewers is stored in viewer list 72, including the TV program that each viewer is currently viewing. Group lists 71 comprises a listing of N groups of viewers, including data identifying each viewer in each of the N groups. As described below in greater detail, viewers may be put into different groups according to a wide variety of criteria.

In the descriptions of the present invention that follow, the associated subscriber monitoring apparatus that communicates bidirectionally with viewed channel monitor 60 is implemented in a set-top box that functions as a disk-based video recorder. Those skilled in the art will understand that this is by way of example only and should not be construed so as to limit the scope of the present invention. In alternate embodiments of the present invention, the subscriber monitoring apparatus may be implemented in a television set, in a conventional video cassette recorder (VCR), in a cable TV converter box, or in a satellite dish control box.

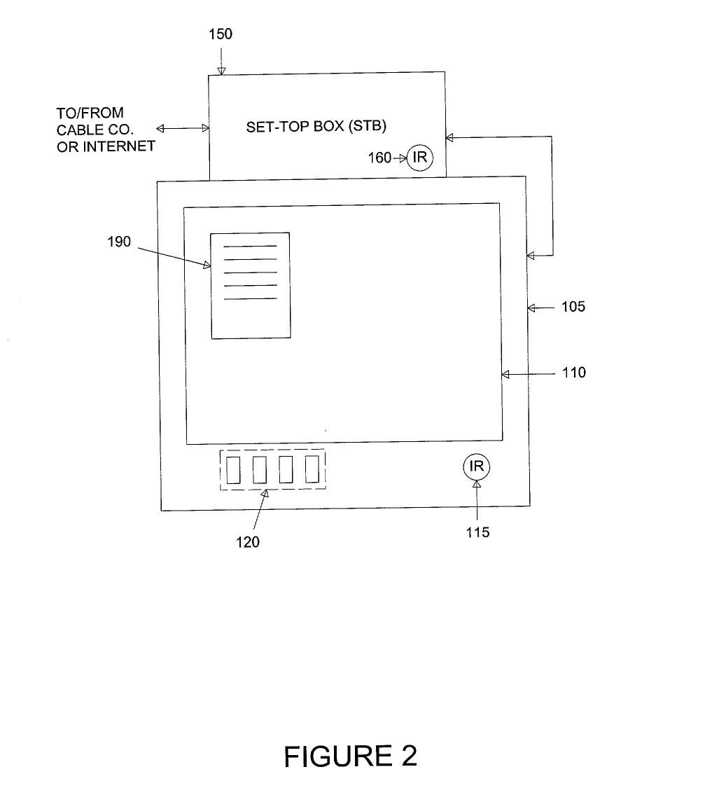

FIG. 2 illustrates exemplary set-top box (STB) 150 and television set 105 according to one embodiment of the present invention. Set-top box 150 receives incoming television signals from local broadcast facility 11, which may be a cable television service provider (Cable Co.) or an Internet service provider (ISP) and transmits a viewer-selected channel to television set 105.

In RECORD mode, set-top box 150 may demodulate an incoming radio frequency (RF) television signal to produce a baseband video signal that is recorded and stored on a storage medium within or connected to set-top box 150. In PLAY mode, set-top box 150 reads a stored baseband video signal (i.e., program) selected by the user from the storage medium and transmits it to television set 105.

For example, if set-top box 150 is a disk drive-based device, such as a ReplayTV™ recorder or a TiVo™ recorder, set-top box 150 stores and retrieves the incoming television signals to and from a computer magnetic hard disk (rather than a magnetic cassette tape). In still other embodiments, set-top box 150 may store and retrieve from a local read/write (R/W) digital versatile disk (DVD) or R/W CD-ROM. Thus, the local storage medium may be fixed (i.e., hard disk drive) or removable (i.e., DVD, CD-ROM).

Set-top box 150 comprises infrared (IR) sensor 160 that receives commands (such as Channel Up, Channel Down, Volume Up, Volume Down, Record, Play, Fast Forward (FF), Reverse, and the like) from a remote control device operated by the viewer. Television set 105 is a conventional television comprising screen 110, infrared (IR) sensor 115, and one or more manual controls 120 (indicated by a dotted line). IR sensor 115 also receives commands (such as volume up, volume down, power ON/OFF) from a remote control device operated by the viewer.

It should be noted that set-top box 150 is not limited to receiving a particular type of incoming television signal from a particular type of source. As noted above, the external source may be a cable service provider, a conventional RF broadcast antenna, a satellite dish, or an Internet connection. Thus, the incoming signal may be a digital signal, an analog signal, or Internet protocol (IP) packets.

However, for the purposes of simplicity and clarity in explaining the principles of the present invention, the descriptions that follow shall generally be directed to an embodiment in which set-top box 150 receives incoming television signals (analog and/or digital) from a cable service provider. Nonetheless, those skilled in the art will understand that the principles of the present invention may readily be adapted for use with wireless broadcast television signals, an incoming stream of IP packets containing MPEG data, and the like.

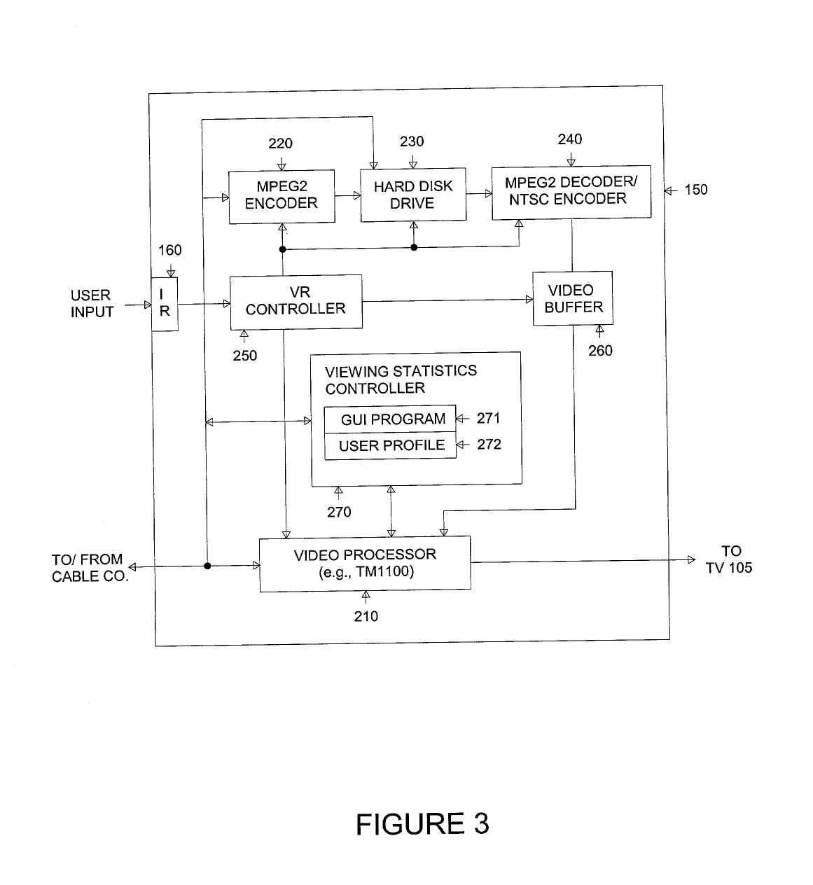

FIG. 3 illustrates exemplary set-top box 150 in greater detail according to one embodiment of the present invention. Set-top box 150 comprises IR sensor 160, video processor 210, MPEG2 encoder 220, hard disk drive 230, MPEG2 decoder/NTSC encoder 240, video recorder (VR) controller 250, video buffer 260, and viewing statistics controller 270. In an advantageous embodiment of the present invention, viewing statistics controller 270 comprises a data processor and an associated memory that stores graphical user interface 271 and user profile data 272. VR controller 250 directs the overall operation of set-top box 150, including View mode, Record mode, Play mode, Fast Forward (FF) mode, Reverse mode, among others.

In View mode, VR controller 250 causes the incoming television signal from the cable service provider to be demodulated and processed by video processor 210 and transmitted to television set 105, without storing or retrieving from hard disk drive 230. Video processor 210, which may be, for example, a TriMedia (TM) 1100 media processor, contains radio frequency (RF) front-end circuitry for receiving incoming television signals from the cable service provider, tuning to a user-selected channel, and converting the selected RF signal to a baseband television signal (e.g., super video signal) suitable for display on television set 105. Video processor 210 also is capable of receiving a conventional NTSC signal from MPEG2 decoder/NTSC encoder 240 (after buffering in video buffer 260) during Play mode and transmitting baseband television signal (e.g., super video signal) to television set 105.

In Record mode, VR controller 250 causes the incoming television signal to be stored on hard disk drive 230. Under the control of VR controller 250, MPEG2 encoder 220 receives the incoming television signal from the cable service provider and converts the received RF signal to MPEG-2 format for storage on hard disk drive 230. Alternatively, if set-top box 150 is coupled to a source that is transmitting MPEG-2 data, the incoming MPEG-2 data may bypass MPEG2 encoder 220 and be stored directly on hard disk drive 230. In Play mode, VR controller 250 directs hard disk drive 230 to stream the stored television signal (i.e., program) to MPEG2 decoder/NTSC encoder 240, which converts the MPEG2 data from hard disk drive 230 to, for example, a super video (S-Video) signal that is buffered in video buffer 260 before video processor 210 transmits it to television set 105.

It should be noted that the choice of the MPEG2 standard for MPEG2 encoder 220 and MPEG2 decoder/NTSC encoder 240 is by way of illustration only. In alternate embodiments of the present invention, the MPEG encoder and decoder may comply with one or more of the MPEG-1, MPEG-2, MPEG-4, and MPEG-7 standards.

For the purposes of this application and the claims that follow, hard disk drive 230 is defined to include any mass storage device that is both readable and writable, including conventional magnetic disk drives and optical disk drives for read/write digital versatile disks (DVD-RW), re-writable CD-ROMs, VCR tapes and the like. In fact, hard disk drive 230 need not be fixed in the conventional sense that is permanently embedded in set-top box 150. Rather, hard disk drive 230 includes any mass storage device that is dedicated to set-top box 150 for the purpose of storing recorded video programs. Thus, hard disk drive 230 may include an attached peripheral drive or removable disk drives (whether embedded or attached), such as a juke box device that holds read/write DVDs or re-writable CD-ROMs. Furthermore, in an advantageous embodiment of the present invention, hard disk drive 230 may include external mass storage devices that set-top box 150 may access and control via a network connection (e.g., Internet protocol (IP) connection), including, for example, a disk drive in the user's home personal computer (PC) or a disk drive on a server at the user's Internet service provider (ISP).

Viewing statistics controller 270 communicates bidirectionally with video processor 210 and viewed channel monitor 60 in local broadcast facility 11. Group viewing statistics of other viewers are transmitted from viewed channel monitor 60 to viewing statistics controller 270. The viewing information related to the viewer operating set-top box 150 is transmitted from viewing statistics controller 270 to viewed channel monitor 60 in local broadcast facility 11.

Under control of GUI program 271, viewing statistics controller 270 displays overlay window 190 on screen 110 of television set 105. Viewing statistics are displayed in window 190 in response to a viewer prompt entered via a remote control. Also, viewer profile data entered by a viewer using a remote control appears in window 190 and is stored by viewing statistics controller 270 in user profile 272. Viewing statistics controller 270 also transmits (uploads) the viewer profile data stored in user profile 272 of each viewer to viewed channel monitor 60 for storage in viewer list 72.

During the course of routine operation, viewing statistics controller 270 monitors the viewer selected channels being processed by video processor 210 and transmits the selected channel information to viewed channel monitor 60. The selected channel information is likewise stored in viewer list 72, thereby maintaining a real-time listing of the television programs (i.e., channels) being watched by each of the viewers in viewer list 72. Whenever the group viewing statistics of a selected group in groups lists 71 are transmitted to viewing statistics controller 270, the viewing statistics for each viewer in the selected group are retrieved from viewer list 72 and downloaded to viewing statistics controller 270 for subsequent display by GUI program 271 in window 190.

Viewing statistics controller 270 and viewed channel monitor 60 provide a unique apparatus and method that allows viewers who are viewing a television program alone or in very small numbers to feel a connection with other people who are also viewing the television program. The present invention enables a viewer to see what TV programs his or her friends are watching, to check the popularity of all TV programs that are currently being broadcast, to sort shows by their viewing popularity, and to check the popularity of a recorded program before they begin viewing.

There are a number of ways that the viewing information can be transmitted to viewing statistics controller 270. In one embodiment, content providers (i.e., broadcasters) can add the viewer statistics into the broadcast stream or via a secondary channel (i.e., Internet connection) coupled to set-top box 150. In the illustrated embodiment in FIG. 1, a service provider (i.e., the cable company) provides the viewer statistics to viewers. Also, a third-party provider may ask viewers to subscribe. These methods could be done in total or by channel, by program, by location, by area of interest, and the like. Data for subscribed viewers could be sent back to individual viewers.

Viewers may interact with viewing statistics controller 270 and viewed channel monitor 60 using a number of different methods. These methods may be active simultaneously. According to an “anonymous viewing” method, a first viewer may observe how many other viewers are currently watching a program, but the first viewer does not know the identities of the other viewers. This would protect the identity of the first viewer, as well. More specifically, each viewer can see how many people have watched a certain program to date, how many people have seen a particular episode, how many people are watching the series, how many people are interested in the statistics of the viewed program.

According to a “group viewing” method, a viewer is able to see how many of the friends of the viewer are watching specific programs. This is of particular interest to teenagers, who often are more interested in watching programs that their friends watch than in watching shows they specifically find interesting. A viewer may use an avatar (i.e., and alias or screen name) to shield his or her identity. The viewer discloses his or her avatar only to members of his or her group. The viewer can also sort and search, keeping the avatars of their closest friends on top.

According to a “special interest viewing” method, a viewer may be a member of one or more groups formed around different topics, similar to Internet boards. One obvious topic of interest would be the specific show viewers are watching. Viewers could see the different screen names or avatars of the other viewers. The viewers could then try to make personal connections by asking questions and hoping someone responds. This is similar to Internet chat groups.

The viewer statistics could be displayed in a variety of manners in window 190. The easiest is numerical data indicating the total number of viewers. In addition, the viewer statistics could appear as a percentage of all viewer statistics (e.g., 10% of all viewers are watching a certain show) or could appear abstracted as a graph. A viewer could sort through different shows based on the following exemplary criteria:

1. Most popular ten shows currently being broadcast

2. Most popular shows that were on last week

3. Most popular shows this season, year, etc.

4. Most popular show that user watches

5. Most popular show that a specific username/avatar watches

6. Viewing history of user/avatar

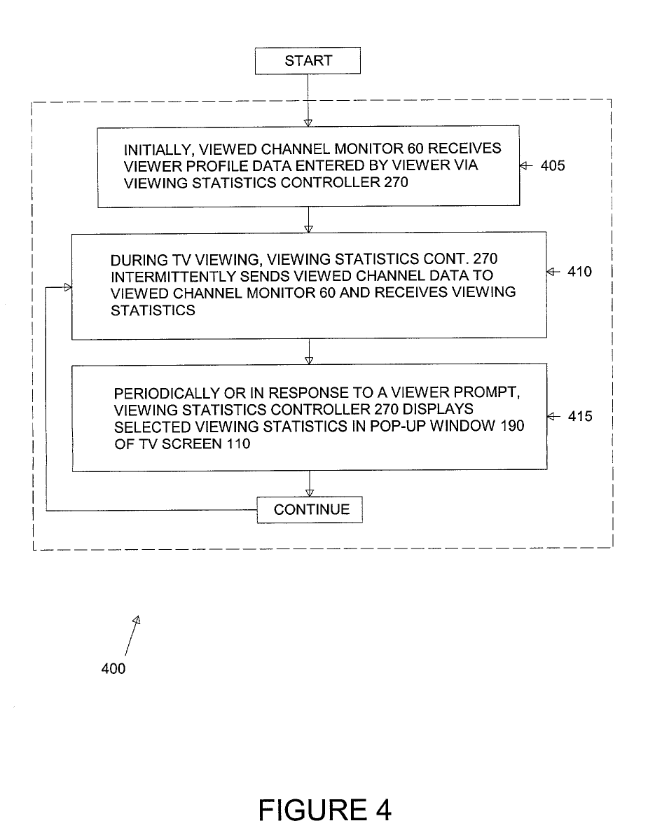

FIG. 4 depicts flow diagram 400, which illustrates the operation of exemplary set-top box 150 and broadcast facility 300 according to one embodiment of the present invention. Initially, viewed channel monitor 60 receives from viewing statistics controller 270 viewer profile data entered by the viewer (process step 405). Thereafter, during television viewing, viewing statistics controller 270 intermittently sends viewed channel data to viewed channel monitor 60 and receives viewing statistics from viewed channel monitor 60 (process step 410). Periodically, or in response to a viewer remote control prompt, viewing statistics controller 270 displays selected viewing statistics in pop-up window 190 of television screen 110 (process step 415).

Although the present invention has been described in detail, those skilled in the art should understand that they can make various changes, substitutions and alterations herein without departing from the spirit and scope of the invention in its broadest form.

What is claimed is:

1. A television apparatus comprising a viewing statistics controller capable of receiving incoming television signals from a broadcast source and extracting from said incoming television signals viewer statistical data transmitted by said broadcast source, wherein said viewing statistics controller displays on a television screen associated with said television apparatus at least a portion of said viewer statistical data associated with a viewer group selected by a viewer operating said television apparatus.

2. The television apparatus as set forth in claim 1 wherein said viewing statistics controller intermittently transmits to said broadcast source viewed channel data identifying television programs viewed by said viewer.

3. The television apparatus as set forth in claim 1 wherein said viewing statistics controller displays said at least a portion of said viewer statistical data in response to a command prompt entered by said viewer.

4. The television apparatus as set forth in claim 1 wherein said viewing statistics controller displays said at least a portion of said viewer statistical data periodically.

5. The television apparatus as set forth in claim 1 wherein members of said viewer group are determined by said viewer and said viewing statistics controller transmits to said broadcast source identification data identifying said members of said viewer group.

6. The television apparatus as set forth in claim 5 wherein receipt of said identification data causes said broadcast source to monitor viewed channel data identifying television programs viewed by said members of said viewer group.

7. The television apparatus as set forth in claim 1 wherein said viewing statistics controller comprises a graphical user interface operable to display on said television screen said at least a portion of said viewer statistical data associated with said viewer group.

8. The television apparatus as set forth in claim 8 wherein said viewer selects said viewer group via said graphical user interface.

9. The television apparatus as set forth in claim 1 wherein said television apparatus is disposed within a television set.

10. The television apparatus as set forth in claim 1 wherein said television apparatus is disposed within a set-top box associated with said television screen.

11. A method of operating a television apparatus comprising the steps of:
receiving incoming television signals from a broadcast source;
extracting from the incoming television signals viewer statistical data transmitted by the broadcast source; and
displaying on a television screen associated with the television apparatus at least a portion of the viewer statistical data associated with a viewer group selected by a viewer operating the television apparatus.

12. The method as set forth in claim 11 further comprising the step of intermittently transmitting to the broadcast source viewed channel data identifying television programs viewed by the viewer.

13. The method as set forth in claim 11 wherein the step of displaying comprises the step of displaying the at least a portion of the viewer statistical data in response to a command prompt entered by the viewer.

14. The method as set forth in claim 11 wherein the step of displaying comprises the step of displaying the at least a portion of the viewer statistical data periodically.

15. The method as set forth in claim 11 wherein members of the viewer group are determined by the viewer and the viewing statistics controller transmits to the broadcast source identification data identifying the members of the viewer group.

16. The method as set forth in claim 15 wherein receipt of the identification data causes the broadcast source to monitor viewed channel data identifying television programs viewed by the members of the viewer group.

17. The method as set forth in claim 11 wherein the television apparatus is disposed within a television set.

18. The method as set forth in claim 11 wherein the television apparatus is disposed within a set-top box associated with the television screen.

19. A broadcast facility capable of transmitting a plurality of televisions signals via a communication network to a plurality of subscriber locations, said broadcast facility comprising:
a monitoring system capable of receiving from television apparatuses disposed in said subscriber locations viewed channel data identifying television programs viewed by viewers at selected ones of said subscriber locations; and
a database coupled to said monitoring system, said database storing viewer statistical data generated from said viewed channel data in a plurality of viewer groups, wherein said monitoring system transmits viewer statistical data associated with a first one of said plurality of viewer groups to a first subscriber location requesting said viewer statistical data.

20. The broadcast facility as set forth in claim 19 wherein members of said first viewer group are determined by a viewer at said first subscriber location.
